(19) United States
(12) Patent Application Publication
(10) Pub. No.: US 2018/0337424 A1
(43) Pub. Date: Nov. 22, 2018

(54) NEGATIVE-ELECTRODE ACTIVE MATERIAL FOR NON-AQUEOUS SECONDARY BATTERY AND NON-AQUEOUS SECONDARY BATTERY

(71) Applicant: Panasonic Intellectual Property Management Co., Ltd., Osaka (JP)

(72) Inventors: TAKAYUKI NAKATSUTSUMI, Osaka (JP); NOBUHIKO HOJO, Tokyo (JP); AKIRA KANO, Osaka (JP); JUNKO MATSUSHITA, Osaka (JP)

(21) Appl. No.: 15/959,292

(22) Filed: Apr. 23, 2018

(30) Foreign Application Priority Data
May 16, 2017 (JP) 2017-097702
Jan. 12, 2018 (JP) 2018-003745

(51) Int. Cl. H01M 10/0525; H01M 4/133; H01M 4/583; H01M 4/134; H01M 4/38; H01M 4/66; H01M 2/20

(52) U.S. Cl. CPC H01M 10/0525; H01M 4/133; H01M 4/583; H01M 2004/027; H01M 4/381; H01M 4/662; H01M 2/204; H01M 4/134

(57) ABSTRACT

A negative-electrode active material comprises: a graphite including boron; and a covering layer that covers a surface of the graphite. The covering layer comprises carbon. A ratio R satisfies 0≤R≤0.001, where R=S_{B}/(S_{B}+S_{C}), and S_{B} denotes a total peak area of a boron 1 s spectrum of the negative-electrode active material obtained by X-ray photoelectron spectroscopy, and S_{C} denotes a total peak area of a carbon 1 s spectrum of the negative-electrode active material obtained by X-ray photoelectron spectroscopy.

### BACKGROUND

### 1. Technical Field

The present disclosure relates to a non-aqueous secondary battery and a negative-electrode active material for use in the non-aqueous secondary battery.

### 2. Description of the Related Art

Carbon materials containing boron have been studied as negative-electrode materials for non-aqueous secondary batteries exemplified by lithium-ion secondary batteries (see Japanese Unexamined Patent Application Publications No. 7-73898 and No. 9-63585, for example).

### SUMMARY

One non-limiting and exemplary embodiment provides a highly reliable negative-electrode active material reducing a decrease in discharge capacity density.

In one general aspect, the techniques disclosed here feature a negative-electrode active material for a non-aqueous secondary battery. the negative-electrode active material comprises: a graphite including boron; and a covering layer that covers a surface of the graphite. The covering layer comprises carbon. A ratio R satisfies 0≤R≤0.001, where R=S_{B}/(S_{B}+S_{C}), and S_{B} denotes a total peak area of a boron 1 s spectrum of the negative-electrode active material obtained by X-ray photoelectron spectroscopy, and S_{C} denotes a total peak area of a carbon 1 s spectrum of the negative-electrode active material obtained by X-ray photoelectron spectroscopy.

A negative-electrode active material for a non-aqueous secondary battery according to an embodiment of the present disclosure has high reliability, reducing a decrease in discharge capacity density.

It should be noted that general or specific embodiments may be implemented as an active material, a battery, a device, a method, or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a schematic cutaway plan view illustrating the structure of a non-aqueous secondary battery according to one embodiment of the present disclosure;

FIG. 2 is a cross-sectional view taken along the line II-II of the non-aqueous secondary battery illustrated in FIG. 1;

FIG. 3A is an explanatory view of a method for preparing a negative electrode for performance evaluation;

FIG. 3B is an explanatory view of a method for preparing a negative electrode for performance evaluation;

FIG. 3C is an explanatory view of a method for preparing a negative electrode for performance evaluation; and

FIG. 4 is a spectrum of a negative-electrode active material of Example 1 obtained by X-ray photoelectron spectroscopy.

### DETAILED DESCRIPTION

Lithium-ion secondary batteries including a negative electrode containing graphite, which can occlude a large amount of lithium in the graphite skeleton and reversibly release the lithium, can have high discharge capacity densities. However, graphite is likely to cause a side reaction with an electrolytic solution.

Thus, it is difficult for lithium-ion secondary batteries including a negative electrode containing graphite both to suppress side reactions and to have a high discharge capacity density. As a result of extensive studies to suppress side reactions between graphite and an electrolytic solution and to achieve a high discharge capacity density, the present inventors have conceived a negative-electrode active material for a non-aqueous secondary battery of the present disclosure.

Embodiments of the present disclosure will be described in detail below. However, the present disclosure is not limited to these embodiments.

A negative-electrode active material for a non-aqueous secondary battery according to an embodiment of the present disclosure contains a boron-containing graphite, and the surface of the graphite is covered with a boron-free covering layer. Such a structure can provide a highly reliable negative electrode for a non-aqueous secondary battery with a high discharge capacity density. Although the reason for enabling both of the high discharge capacity density and suppression of side reactions of such a negative-electrode active material for a non-aqueous secondary battery is not completely clear, the present inventors guess the reason as described below. However, the present disclosure is not limited by the following discussion. Desorption of lithium ions from a negative electrode is hereinafter referred to as discharge, and adsorption of lithium ions onto the negative electrode is hereinafter referred to as charge.

Graphite is likely to cause a side reaction with an electrolytic solution. This is probably because graphite has a low charge potential and a low discharge potential, and thus has high reducing power. Therefore, reductive decomposition of a non-aqueous electrolytic solution on the surface of the negative electrode is likely caused as a side reaction.

In contrast, in an embodiment of the present disclosure, boron atoms in the graphite skeleton increase the charge potential and discharge potential of the graphite. This decreases the reducing power of the negative electrode, which is responsible for a side reaction with an electrolytic solution, and thereby suppresses a side reaction with the electrolytic solution and improves reliability.

Boron-free graphite, which can occlude many lithium ions in its skeleton and reversibly release the lithium ions, has a high discharge capacity density. Like boron-free graphite, boron-containing graphite can also occlude many lithium ions. However, part of lithium ions occluded on boron-containing graphite may be trapped (e.g. fixed) by boron or boron-derived defects on the surface of the graphite. Trapped lithium ions cannot be reversibly released and do not contribute to charge-discharge. Thus, the discharge capacity decreases with the number of boron sites or boron-derived defect sites that trap lithium ions.

In contrast, in an embodiment of the present disclosure, the boron-free carbon covering the surface of the graphite inhibits boron from trapping lithium ions. This suppresses a decrease in discharge capacity and results in a discharge capacity density similar to that of boron-free graphite. The covering layer is formed of amorphous carbon, for example.

The covering layer desirably has a thickness of 30 nm or more. This can inhibit boron from trapping lithium ions and provide a high discharge capacity density. The covering layer has a thickness of 1 μm or less, and desirably 100 nm or less, so as not to restrict the movement or adsorption of lithium ions into the graphite. Thus, a high discharge capacity density can be achieved. The thickness of the covering layer can be measured by determining the depth at which a boron 1 s spectrum can be detected by X-ray photoelectron spectroscopy while etching the covering layer with an Ar ion gun, for example.

Such a structure can provide a negative-electrode active material containing graphite with a high discharge capacity density and improved reliability.

The thickness and coverage of the covering layer that covers the graphite are desirably such that the ratio R of S_{B} to (S_{B}+S_{C}) (i.e., S_{B}/(S_{B}+S_{C}), hereinafter also referred to “S_{B}/(S_{B}+S_{C}) ratio”) is equal to or more than 0 and 0.001 or less, wherein S_{B} denotes the total peak area of a boron 1 s spectrum of the negative-electrode active material obtained by X-ray photoelectron spectroscopy, and S_{C} denotes the total peak area of a carbon 1 s spectrum of the negative-electrode active material obtained by X-ray photoelectron spectroscopy.

When the ratio R of S_{B} to (S_{B}+S_{C}) is 0.001 or less, this means that the ratio of boron to carbon in a measurement region near the surface of the covering layer is a certain value (0.1% without consideration of a difference in spectral intensity between boron and carbon) or less. Because the covering layer contains no boron, as described above, a spectrum of boron, if observed at all, results from boron in the graphite under the covering layer. Thus, a thicker covering layer or a higher coverage results in less boron in the measurement region and a lower R. A ratio R of 0.001 or less means that the surface of boron-containing graphite is covered with a boron-free covering layer. A thick covering layer with R of 0.001 or less, or with almost no detection of boron, or covering the entire surface can result in a high discharge capacity density.

X-ray photoelectron spectroscopy (XPS) analyzes the element composition and chemical bonding state of a surface of a sample by irradiating the surface of the sample with X-rays and measuring the kinetic energy of photoelectrons released from the surface of the sample. The peak areas S_{B} and S_{C} can be measured and calculated under the following conditions. A graphite C1 s spectrum (248.5 eV) can be used for energy calibration.

Measuring apparatus: PHI 5000 VersaProbe manufactured by ULVAC-PHI, Inc.

X-ray source: monochromatic Mg—Kα radiation, 200 nmΦ, 45 W, 17 kV

Area of analysis: approximately 200 μmΦ

The peak area S_{B} of the boron 1 s spectrum can be calculated as the total peak area of a spectrum in the binding energy range of 184.0 to 196.5 eV. Likewise, the peak area S_{C} of the carbon 1 s spectrum can be calculated as the total peak area of a spectrum in the binding energy range of 281.0 to 293.0 eV.

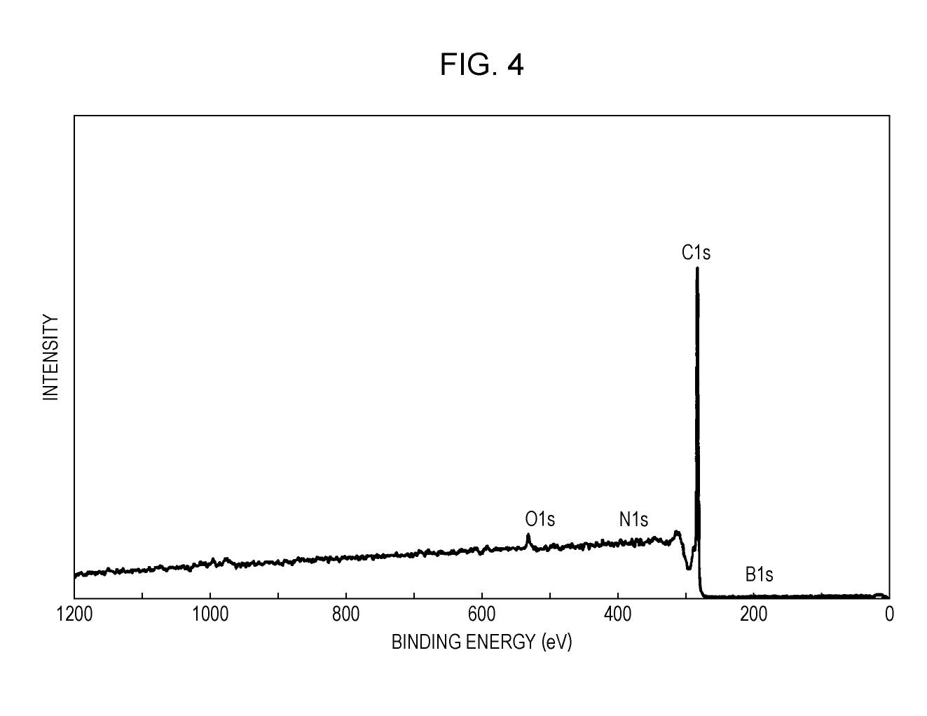

FIG. 4 shows a spectrum of a negative-electrode active material of Example 1 described later obtained by X-ray photoelectron spectroscopy. In FIG. 4, the spectrum of the negative-electrode active material includes a carbon 1 s spectrum (C1 s in the figure) as the main peak, a boron 1 s spectrum (B1 s in the figure), and a nitrogen 1 s spectrum (N1 s in the figure). The total peak area S_{B} of the boron 1 s spectrum and the total peak area S_{C} of the carbon 1 s spectrum can be calculated by automatic integration from the spectrum of the negative-electrode active material.

The boron content of the graphite is desirably 0.01% or more by mass of the total amount of the graphite, and desirably 5% or less by mass of the total amount of the graphite. A graphite with a boron content of 5% or less by mass can suppress the formation of by-products not involved in adsorption or desorption of lithium ions and achieve a high discharge capacity density. A graphite with a boron content of 0.01% or more by mass can sufficiently suppress side reactions. In consideration of reliability and the discharge capacity density, the graphite desirably has a boron content in the range of 0.01% to 5% by mass, more desirably 0.1% to 1% by mass, and still more desirably 0.1% to 0.5% by mass.

In an exemplary method for synthesizing a negative-electrode active material, after a boron-containing graphite is synthesized, the surface of graphite can be covered with a boron-free carbon by vapor deposition, such as chemical vapor deposition (CVD), sputtering, or atomic layer deposition (ALD), a sol-gel method, or a water thermal reaction, or with a ball mill.

In the synthesis of a boron-containing graphite, for example, a carbon precursor material is mixed with a boron raw material and is fired at a temperature in the range of approximately 2100° C. to 3000° C. in an inert gas atmosphere to promote graphitization and to facilitate solid solution of boron in the carbon skeleton. The firing atmosphere desirably contains an inert gas, such as argon.

The carbon precursor material may be soft carbon, such as petroleum coke or coal coke. The soft carbon may have the shape of sheet, fiber, or particles. The carbon precursor material may be synthetic resin having the shape of particles or short fibers in size of a few to tens of micrometers, in consideration of processing after firing. Carbon serving as a raw material can also be produced by heat-treating an organic material, such as a synthetic resin, at a temperature in the range of approximately 800° C. to 1000° C. to evaporate elements other than carbon.

Examples of the boron raw material include boron, boric acid, boron oxide, boron nitride, and diborides, such as aluminum diboride and magnesium diboride. The mass ratio of boron to carbon in the carbon and boron raw materials may range from 0.01% to 5%. During high-temperature firing, part of boron is sometimes not incorporated into the carbon material and volatilizes. Thus, the boron content of the carbon material may be decreased by firing. The boron source may be added after graphitization of carbon.

The boron raw material may be added after graphitization of the carbon precursor material. More specifically, a negative-electrode active material according to the present embodiment can be produced by adding the boron raw material to the material subjected to graphitization, firing the material again at a temperature in the range of approximately 2100° C. to 3000° C., and covering the material with boron-free carbon.

Graphite is the generic name of a carbon material that contains a region having a structure including planes of carbon atoms arranged in hexagonal arrays with the planes stacked regularly. Examples of graphite include natural graphite, artificial graphite, and graphitized mesophase carbon particles. The (002) interplanar spacing d₀₀₂ (the interplanar spacing between planes of carbon atoms) measured by X-ray diffractometry is utilized as a measure of the growth of a graphite crystal structure. In general, highly crystalline carbon with d₀₀₂ of 3.4 angstroms or less and a crystallite size of 100 angstroms or more is referred to as graphite. The crystallite size can be measured by the Scherrer method, for example.

In a method for covering the surface of graphite with a covering layer, first, graphite particles are mixed with amorphous carbon, such as carbon black, easily graphitizable carbon, or non-graphitizable carbon, and the mixture is subjected to shear force. The mixture can be subjected to shear force with a shear mixer, a ball mill, or a bead mill.

In a method for covering the surface of graphite with an amorphous carbon covering layer, graphite particles are mixed with a raw material for amorphous carbon to cover at least part of the surface of the graphite particles with the raw material for amorphous carbon, and the mixture is fired. The raw material forms amorphous carbon by firing. The firing temperature is a temperature at which no graphitization occurs (800° C. to 2000° C.). The firing atmosphere is desirably an inert atmosphere, such as nitrogen or argon. When the raw material for amorphous carbon is a viscous liquid, such as pitch or tar, at least part of the surface of the graphite particles is desirably covered in a fluidized bed. A viscous liquid, such as pitch or tar, and carbon black may be used in combination. For example, a mixture of a viscous liquid and carbon black may be used as a raw material for amorphous carbon. The raw material for amorphous carbon may also be an organic polymer. In this case, a polymer solution may be sprayed and dried on graphite particles, thereby covering at least part of the surface of graphite particles with the organic polymer.

Alternatively, graphite particles may be heated in a hydrocarbon gas atmosphere to deposit amorphous carbon formed by pyrolysis of the hydrocarbon gas on the surface of graphite. The hydrocarbon gas may be methane, ethane, ethylene, propylene, or acetylene.

A non-aqueous secondary battery containing the negative-electrode active material will be described below.

The non-aqueous secondary battery includes a positive electrode, a negative electrode, and a non-aqueous electrolytic solution.

The positive electrode contains a positive-electrode active material that can occlude and release alkali metal ions. The negative electrode contains a negative-electrode active material. The negative-electrode active material contains the boron-containing graphite. The non-aqueous electrolytic solution contains an alkali metal salt composed of an alkali metal ion and an anion dissolved in a non-aqueous solvent. The alkali metal ion is a lithium ion, for example. The alkali metal ion may be another alkali metal ion, such as a sodium ion.

Such a non-aqueous secondary battery can have a high discharge capacity density and high reliability.

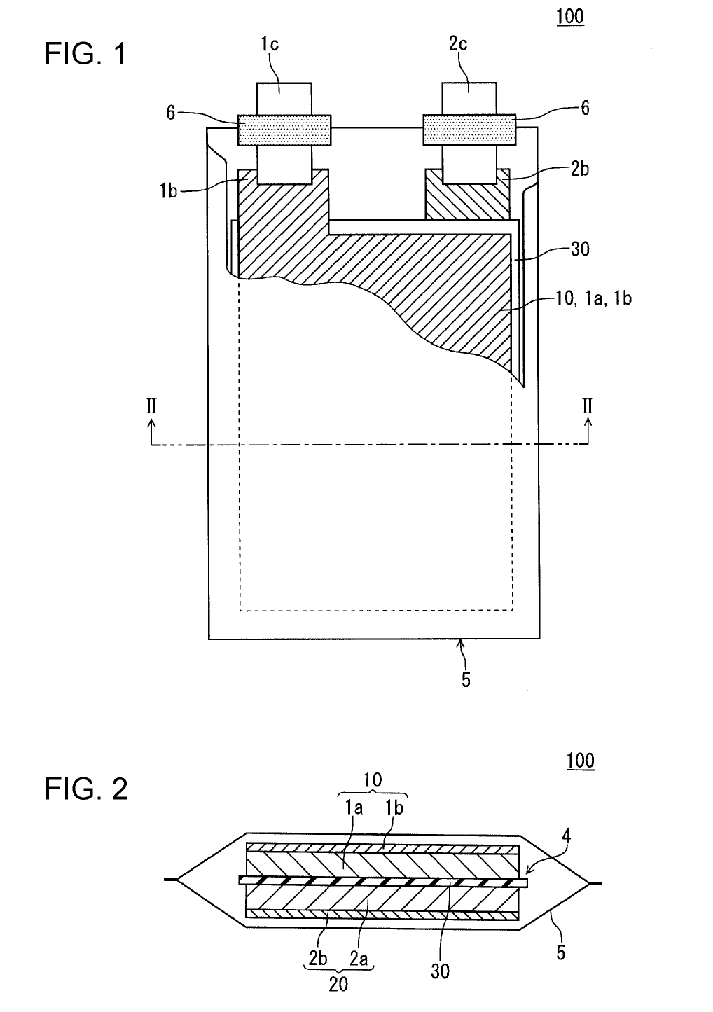

A lithium-ion secondary battery will be described below with reference to FIGS. 1 and 2 as an example of a non-aqueous secondary battery according to one embodiment of the present disclosure. FIG. 1 is a schematic cutaway plan view of a non-aqueous secondary battery (for example, a lithium-ion secondary battery). FIG. 2 is a cross-sectional view taken along the line II-II of FIG. 1.

As illustrated in FIGS. 1 and 2, a lithium-ion secondary battery 100 is a sheet-type battery and includes an electrode assembly 4 and a casing 5 for the electrode assembly 4.

The electrode assembly 4 includes a positive electrode 10, a separator 30, and a negative electrode 20 stacked in this order. The positive electrode 10 faces the negative electrode 20 with the separator 30 interposed therebetween. The electrode assembly 4 is thus formed. The electrode assembly 4 is impregnated with a non-aqueous electrolytic solution (not shown).

The positive electrode 10 includes a positive-electrode mixture layer 1a and a positive-electrode current collector 1b. The positive-electrode mixture layer 1a is adjacent to the separator 30 on the positive-electrode current collector 1b.

The negative electrode 20 includes a negative-electrode mixture layer 2a and a negative-electrode current collector 2b. The negative-electrode mixture layer 2a is adjacent to the separator 30 on the negative-electrode current collector 2b.

The positive-electrode current collector 1b is connected to a positive-electrode tape automated bonding (tab) lead 1c, and the negative-electrode current collector 2b is connected to a negative-electrode tab lead 2c. The positive-electrode tab lead 1c and the negative-electrode tab lead 2c extend outside the casing 5.

The spaces between the positive-electrode tab lead 1c and the casing 5 and between the negative-electrode tab lead 2c and the casing 5 are insulated by an insulating tab film 6.

The positive-electrode mixture layer 1a contains a positive-electrode active material that can occlude and release alkali metal ions. The positive-electrode mixture layer 1a may contain a conductive aid, an ionic conductor, and a binder, as required. The positive-electrode active material, conductive aid, ionic conductor, and binder may contain any known material.

The positive-electrode active material may be any material that can occlude and release one or more alkali metal ions, for example, a transition metal oxide, a transition metal fluoride, a polyanionic material, a fluorinated polyanionic material, or a transition metal sulfide, each containing an alkali metal. For example, the positive-electrode active material is a lithium-containing transition metal oxide, a lithium-containing polyanionic material, or a sodium-containing transition metal oxide. The lithium-containing transition metal oxide is, for example, LiₓMe_{y}O₂ or Li₁₊ₓMe_{y}O₃ (where x satisfies 0<x≤1, y satisfies 0.95≤y<1.05, and Me contains at least one selected from the group consisting of Co, Ni, Mn, Fe, Cr, Cu, Mo, Ti, and Sn). The lithium-containing polyanionic material is, for example, LiₓMe_{y}PO₄ or LiₓMe_{y}P₂O₇ (where x satisfies 0<x≤1, y satisfies 0.95≤y<1.05, and Me contains at least one selected from the group consisting of Co, Ni, Mn, Fe, Cu, and Mo). The a sodium-containing transition metal oxide is, for example, NaₓMe_{y}O₂ (where x satisfies 0<x≤1, y satisfies 0.95≤y<1.05, and Me contains at least one selected from the group consisting of Co, Ni, Mn, Fe, Cr, Cu, Mo, Ti, and Sn).

The positive-electrode current collector 1b may be a porous or nonporous sheet or film formed of a metal material, such as aluminum, an aluminum alloy, stainless steel, nickel, or a nickel alloy. Aluminum and alloys thereof, which are inexpensive and can be easily formed into a thin film, are suitable for the positive-electrode current collector 1b. In order to decrease the resistance, provide catalytic effects, and strengthen the bonding between the positive-electrode mixture layer 1a and the positive-electrode current collector 1b, a carbon material, such as carbon, may be applied to the positive-electrode current collector 1b.

The negative-electrode mixture layer 2a contains as a negative-electrode active materials a boron-containing graphite material according to the present embodiment and a carbon covering layer that covers the surface of the graphite material. The negative-electrode mixture layer 2a may further contain another negative-electrode active material that can occlude and release alkali metal ions, as required. The negative-electrode mixture layer 2a may contain a conductive aid, an ionic conductor, and a binder, as required. The active materials, conductive aid, ionic conductor, and binder may contain any known material.

A negative-electrode active material that may be used in combination with a negative-electrode active material according to the present embodiment may be a material that occludes and releases alkali metal ions or may be an alkali metal. The material that occludes and releases alkali metal ions may be an alkali metal alloy, carbon, a transition metal oxide, or a silicon material. More specifically, the negative-electrode material for a lithium secondary battery may be an alloy of a metal, such as Zn, Sn, or Si, and lithium, carbon, such as artificial graphite, natural graphite, or non-graphitizable amorphous carbon, a transition metal oxide, such as Li₄Ti₅O₁₂, TiO₂, or V₂O₅, SiOₓ (0<x≤2), or lithium metal.

Examples of the conductive aid include carbon materials, such as carbon black, graphite, and acetylene black, and electrically conductive polymers, such as polyaniline, polypyrrole, and polythiophene. Examples of the ionic conductor include gel electrolytes, such as poly(methyl methacrylate), and solid electrolytes, such as poly(ethylene oxide), lithium phosphate, and lithium phosphorus oxynitride (LiPON). Examples of the binder include poly(vinylidene difluoride), vinylidene fluoride-hexafluoropropylene copolymers, vinylidene fluoride-tetrafluoroethylene copolymers, polytetrafluoroethylene, carboxymethylcellulose, poly(acrylic acid), styrene-butadiene copolymer rubber, polypropylene, polyethylene, and polyimide.

The negative-electrode current collector 2b may be a porous or nonporous sheet or film formed of a metal material, such as aluminum, an aluminum alloy, stainless steel, nickel, a nickel alloy, copper, or a copper alloy. Copper and alloys thereof, which are stable at the operating potential of the negative electrode and are relatively inexpensive, are suitable for the material of the negative-electrode current collector 2b. The sheet or film may be a metal foil or metal mesh. In order to decrease the resistance, provide catalytic effects, and strengthen the bonding between the negative-electrode mixture layer 2a and the negative-electrode current collector 2b, a carbon material, such as carbon, may be applied to the negative-electrode current collector 2b.

The separator 30 may be a porous film formed of polyethylene, polypropylene, glass, cellulose, or ceramic. The pores of the separator 30 are filled with a non-aqueous electrolytic solution.

The non-aqueous electrolytic solution is a solution of an alkali metal salt in a non-aqueous solvent. The non-aqueous solvent may be a known cyclic carbonate, chain carbonate, cyclic carboxylate, chain carboxylate, chain nitrile, cyclic ether, or chain ether. The non-aqueous solvent desirably contains a cyclic carbonate and a chain carbonate in terms of the solubility of a Li salt and viscosity.

Examples of the cyclic carbonate include ethylene carbonate, fluoroethylene carbonate, propylene carbonate, butylene carbonate, vinylene carbonate, vinyl ethylene carbonate, and derivatives thereof. These may be used alone or in combination. From the perspective of the ionic conductivity of the electrolytic solution, it is desirable to use at least one selected from the group consisting of ethylene carbonate, fluoroethylene carbonate, and propylene carbonate.

Examples of the chain carbonate include dimethyl carbonate, ethyl methyl carbonate, and diethyl carbonate. These may be used alone or in combination.

Examples of the cyclic carboxylate include γ-butyrolactone and γ-valerolactone. These may be used alone or in combination.

Examples of the chain carboxylate include methyl acetate, ethyl acetate, propyl acetate, methyl propionate, ethyl propionate, and propyl propionate. These may be used alone or in combination.

Examples of the chain nitrile include acetonitrile, propionitrile, butyronitrile, valeronitrile, isobutyronitrile, and pivalonitrile. These may be used alone or in combination.

Examples of the cyclic ether include 1,3-dioxolane, 1,4-dioxolane, tetrahydrofuran, and 2-methyltetrahydrofuran. These may be used alone or in combination.

Examples of the chain ether include 1,2-dimethoxyethane, dimethyl ether, diethyl ether, dipropyl ether, ethyl methyl ether, diethylene glycol dimethyl ether, diethylene glycol diethyl ether, and diethylene glycol dibutyl ether. These may be used alone or in combination.

The hydrogen atoms of these solvents may be partly substituted with fluorine. Thus, these solvents may be fluorinated solvents. A solvent containing fluorine produced by substitution of part of the hydrogen atoms with fluorine can provide a dense film on the negative electrode. Such a dense film on the negative electrode can suppress the continuous decomposition of the electrolytic solution and can thereby provide a highly reliable secondary battery with less side reactions.

Examples of the alkali metal salt to be dissolved in the non-aqueous solvent include lithium salts, such as LiClO₄, LiBF₄, LiPF₆, LiN(SO₂F)₂, LiN(SO₂CF₃)₂, and lithium bisoxalate borate (LiBOB), and sodium salts, such as NaClO₄, NaBF₄, NaPF₆, NaN(SO₂F)₂, and NaN(SO₂CF₃)₂. In particular, it is desirable to use a lithium salt in terms of the overall characteristics of the non-aqueous secondary battery. It is particularly desirable to use at least one selected from the group consisting of LiBF₄, LiPF₆, and LiN(SO₂F)₂ in terms of ionic conductivity.

The number of moles of alkali metal salt in the non-aqueous electrolytic solution in the present embodiment is desirably, but not limited to, in the range of 0.5 to 2.0 mol/L. It is reported that high-salt-concentration electrolytic solutions with a mole ratio of an alkali metal salt to solvent being in the range of 1:1 to 1:4 can also be used for charge-discharge in the same manner as in ordinary electrolytic solutions. Thus, such a high-concentration electrolytic solution may also be used.

There are various types (e.g., shapes) of secondary batteries, such as a coin type, a button type, a multilayer type, a cylindrical type, a flat type, and a square or rectangular type, as well as a sheet type illustrated in FIGS. 1 and 2. A non-aqueous secondary battery according to the present embodiment can be applied to a non-aqueous secondary battery of any shape. The uses of a secondary battery according to the present embodiment include, but are not limited to, personal digital assistants, portable electronic devices, household power storage systems, industrial power storage systems, motorcycles, electric vehicles (EVs), and plug-in hybrid electric vehicles (PHEVs).

The embodiments of the present disclosure will be further described in the following examples.

### Example 1

### (1) Synthesis of Negative-Electrode Active Material

A petroleum coke powder with an average particle size of 12 μm and boric acid (CAS No. 10043-35-3) were ground in an agate mortar. The boric acid was 10% by mass of the petroleum coke powder (boron was 1.7% by mass of the petroleum coke powder). The mixture was then heated from room temperature to 2800° C. at 10° C./min in a tube furnace in an Ar atmosphere (Ar gas flow rate: 1 L/min) and was held at 2800° C. for 1 hour. Subsequently, heating was stopped. After natural cooling, the carbon material was removed from the furnace. The resulting graphite material had an average particle size (median size) of 20 μm measured by laser diffractometry.

The boron-containing graphite material was covered with carbon by rotating CVD. The carbon source gas was acetylene, and the carrier gas was Ar. Covering at 800° C. for 2.5 hours was followed by heat treatment at 1000° C. for 1 hour. Thus, a negative-electrode active material for a non-aqueous secondary battery was produced.

The coverage with the covering layer was 0.6% by mass as calculated from the weights before and after the carbon coverage.

An analysis of the surface of the negative-electrode active material by X-ray photoelectron spectroscopy (XPS) showed no detection of the boron 1 s spectrum. FIG. 4 shows an XPS spectrum as a result of the analysis.

More specifically, the ratio R of S_{B} to (S_{B}+S_{C}) was 0.001 or less, wherein S_{B} denotes the total peak area of a boron 1 s spectrum of the negative-electrode active material obtained by X-ray photoelectron spectroscopy, and S_{C} denotes the total peak area of a carbon 1 s spectrum of the negative-electrode active material obtained by X-ray photoelectron spectroscopy.

An XPS measurement while etching the surface of the negative-electrode active material particles with an Ar ion gun (2 kV, 7 mA) showed that the boron 1 s spectrum increased at a depth of approximately 30 nm or more from the outermost surface. Thus, the covering layer had a thickness of approximately 30 nm.

The negative-electrode active material had a boron content of 0.34% by mass as determined by inductively coupled plasma (ICP) spectrometry.

### (2) Preparation of Test Electrode

The negative-electrode active material for a non-aqueous secondary battery produced by the synthesis method, carboxymethylcellulose (CAS No. 9000-11-7), and a styrene-butadiene copolymer rubber (CAS No. 9003-55-8) were dispersed in pure water at a weight ratio of 97:2:1 to prepare a slurry. The slurry was applied to the negative-electrode current collector 2b formed of a copper foil 10 μm in thickness with a coating machine and was rolled with a rolling mill to form an electrode sheet.

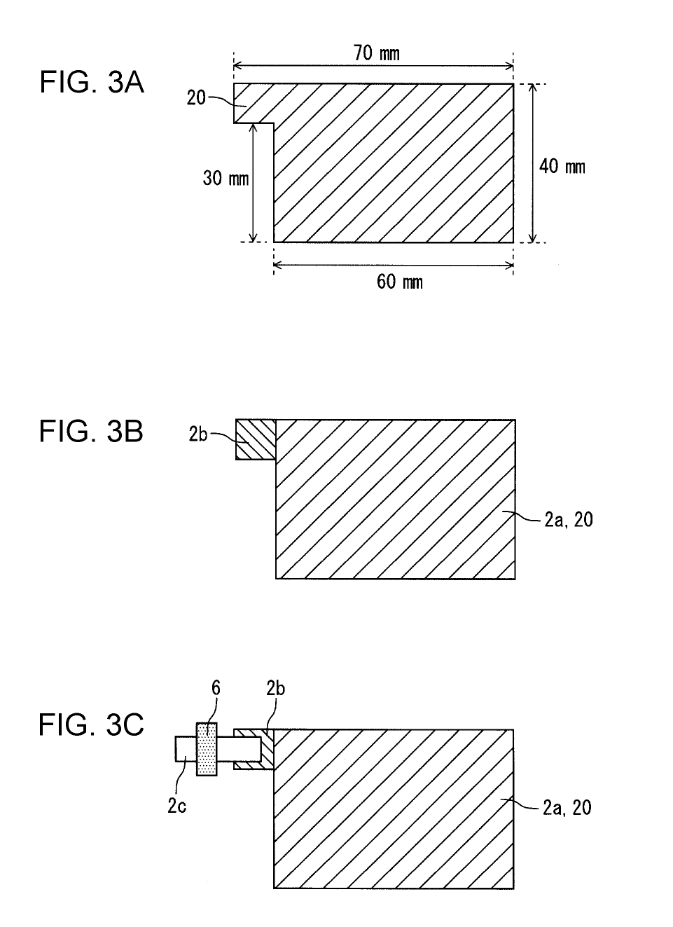

The rolled electrode sheet was cut in the shape illustrated in FIG. 3A to prepare the negative electrode 20 for performance evaluation. In FIG. 3A, a 60 mm×40 mm region functions as a negative electrode, and a 10 mm×10 mm protrusion is a connection region to be connected to the tab lead 2c. As illustrated in FIG. 3B, a portion of the negative-electrode mixture layer 2a on the connection region was scraped off to expose the negative-electrode current collector (copper foil) 2b. As illustrated in FIG. 3C, the exposed portion of the negative-electrode current collector (copper foil) 2b was connected to the negative-electrode tab lead 2c, and a predetermined region around the negative-electrode tab lead 2c was covered with an insulating tab film 6.

### (3) Preparation of Non-Aqueous Electrolytic Solution

In a mixed solvent of fluoroethylene carbonate (CAS No. 114435-02-8) and dimethyl carbonate (CAS No. 616-38-6) (volume ratio: 1:4), 1.2 mol/L LiPF₆ (CAS No. 21324-40-3) was dissolved to prepare an electrolytic solution. The electrolytic solution was prepared in an Ar atmosphere in a glove box at a dew point of −60° C. or less and at an oxygen level of 1 ppm or less.

### (4) Preparation of Evaluation Cell

The negative electrode for performance evaluation was used to prepare a half-cell for negative electrode evaluation. The half-cell included a lithium metal counter electrode. The evaluation cell was prepared in an Ar atmosphere in a glove box at a dew point of −60° C. or less and at an oxygen level of 1 ppm or less.

The negative electrode for performance evaluation connected to the negative-electrode tab lead 2c was put on the Li metal counter electrode connected to a nickel tab lead with a polypropylene separator 30 (30 μm in thickness) interposed therebetween to form an electrode assembly 4.

A 120×120 mm rectangular Al laminated film (100 μm in thickness) was folded in half. An end portion on the 120-mm long side was heat-sealed at 230° C. to form a 120×60 mm envelope. The electrode assembly 4 was inserted into the envelope through a 60-mm short side. An end face of the Al laminated film and a hot-melt resin of the tab leads 1c and 2c were aligned and heat-sealed at 230° C. Subsequently, 0.3 cc of a non-aqueous electrolytic solution was injected through an unsealed short side of the Al laminated film. Standing at a reduced pressure of 0.06 MPa for 15 minutes allowed the negative-electrode mixture layer 2a to be impregnated with the electrolytic solution. Finally, the unsealed end face of the Al laminated film was heat-sealed at 230° C.

### (5) Evaluation of Battery Performance

The electrode assembly 4 in the laminate was placed between 80×80 cm stainless steel sheets (2 mm in thickness), and the evaluation cell was pressurized with clamps at 0.2 MPa. The evaluation was performed in a thermostat at 25° C.

Four cycles of charge-discharge were performed at a limited charge-discharge current with a current density of 20 mA per gram of the negative-electrode active material. Charging was completed at a negative-electrode potential of 0.0 V (vs. Li counter electrode), and discharging was completed at a negative-electrode potential of 1.0 V (vs. Li counter electrode). The battery was left standing in an open circuit for 20 minutes between charging and discharging.

Another cycle of charge-discharge was then performed under the same conditions. In this fifth cycle, the discharge capacity and irreversible capacity per weight of the negative-electrode active material were determined.

### Example 2

A negative-electrode active material for a non-aqueous secondary battery was synthesized in the same manner as in Example 1 except that the boron-containing graphite material was covered with carbon by rotating CVD for 5 hours.

The coverage with the covering layer was 1.2% by mass as calculated from the weights before and after the carbon coverage.

An analysis of the surface of the negative-electrode active material by X-ray photoelectron spectroscopy showed no detection of the boron 1 s spectrum. More specifically, the ratio R defined in Example 1 was 0.001 or less.

An XPS measurement while etching the surface of the negative-electrode active material particles with an Ar ion gun (2 kV, 7 mA) showed that the boron 1 s spectrum increased at a depth of approximately 55 nm or more from the outermost surface. Thus, the covering layer had a thickness of approximately 55 nm.

The negative-electrode active material had a boron content of 0.32% by mass as determined by ICP spectrometry.

### Example 3

A negative-electrode active material for a non-aqueous secondary battery was synthesized in the same manner as in Example 1 except that the amount of boric acid was 5% by mass of the amount of petroleum coke powder.

The resulting negative-electrode active material had an average particle size (median size) of 20 μm measured by laser diffractometry.

The coverage with the covering layer was 1.2% by mass as calculated from the weights before and after the carbon coverage.

An analysis of the surface of the negative-electrode active material by X-ray photoelectron spectroscopy showed no detection of the boron 1 s spectrum. More specifically, the ratio R defined in Example 1 was 0.001 or less.

An XPS measurement while etching the surface of the negative-electrode active material particles with an Ar ion gun (2 kV, 7 mA) showed that the boron 1 s spectrum increased at a depth of approximately 30 nm or more from the outermost surface. Thus, the covering layer had a thickness of approximately 30 nm.

The negative-electrode active material had a boron content of 0.19% by mass as determined by ICP spectrometry.

### Example 4

A negative-electrode active material for a non-aqueous secondary battery was synthesized in the same manner as in Example 1 except that the amount of boric acid was 20% by mass of the amount of petroleum coke powder.

The resulting negative-electrode active material had an average particle size (median size) of 20 μm measured by laser diffractometry.

The coverage with the covering layer was 1.2% by mass as calculated from the weights before and after the carbon coverage.

An analysis of the surface of the negative-electrode active material by X-ray photoelectron spectroscopy showed no detection of the boron 1 s spectrum. More specifically, the ratio R defined in Example 1 was 0.001 or less.

An XPS measurement while etching the surface of the negative-electrode active material particles with an Ar ion gun (2 kV, 7 mA) showed that the boron 1 s spectrum increased at a depth of approximately 30 nm or more from the outermost surface. Thus, the covering layer had a thickness of approximately 30 nm.

The negative-electrode active material had a boron content of 0.42% by mass as determined by ICP spectrometry.

### Comparative Example 1

A negative-electrode active material for a non-aqueous secondary battery was synthesized in the same manner as in Example 1 except that carbon coverage by CVD was not performed.

An analysis of the surface of the negative-electrode active material by X-ray photoelectron spectroscopy showed the detection of the boron 1 s spectrum. The ratio R defined in Example 1 was 0.052.

The negative-electrode active material had a boron content of 0.35% by mass as determined by ICP spectrometry.

### Comparative Example 2

A negative-electrode active material for a non-aqueous secondary battery was synthesized in the same manner as in Example 1 except that no boric acid was added in the synthesis of graphite.

An analysis of the surface of the negative-electrode active material by X-ray photoelectron spectroscopy showed no detection of the boron 1 s spectrum. More specifically, the ratio R defined in Example 1 was 0.001 or less.

The negative-electrode active material had a boron content of 0.01% by mass or less as determined by ICP spectrometry.

### Comparative Example 3

A negative-electrode active material for a non-aqueous secondary battery was synthesized in the same manner as in Example 1 except that carbon coverage by CVD was not performed and that no boric acid was added in the synthesis of graphite.

An analysis of the surface of the negative-electrode active material by X-ray photoelectron spectroscopy showed no detection of the boron 1 s spectrum. More specifically, the ratio R defined in Example 1 was 0.001 or less.

The negative-electrode active material had a boron content of 0.01% by mass or less as determined by ICP spectrometry.

### Comparative Example 4

A negative-electrode active material for a non-aqueous secondary battery was synthesized in the same manner as in Comparative Example 1 except that the amount of boric acid was 20% by mass of the amount of petroleum coke powder.

The resulting negative-electrode active material had an average particle size (median size) of 20 μm measured by laser diffractometry.

The surface of the negative-electrode active material was analyzed by X-ray photoelectron spectroscopy. The ratio R defined in Example 1 was 0.055.

The negative-electrode active material had a boron content of 0.45% by mass as determined by ICP spectrometry.

### Comparative Example 5

A negative-electrode active material synthesized in the same manner as in Comparative Example 1 was again heated from room temperature to 2800° C. at 10° C./min in a tube furnace in an Ar atmosphere (Ar gas flow rate: 1 L/min) and was held at 2800° C. for 1 hour. Subsequently, heating was stopped. After natural cooling, the carbon material was removed from the furnace. The resulting negative-electrode active material had an average particle size (median size) of 20 μm measured by laser diffractometry.

The surface of the negative-electrode active material was analyzed by X-ray photoelectron spectroscopy. The ratio R defined in Example 1 was 0.004.

The negative-electrode active material had a boron content of 0.30% by mass as determined by ICP spectrometry.

Electrode sheets and evaluation cells containing these negative-electrode active materials were produced in the same manner as in the battery of Example 1. The discharge capacity and irreversible capacity were measured as described above. Table 1 shows the results.

Table 1 lists the discharge capacities and irreversible capacities of the negative-electrode active materials of Examples 1 to 4 and Comparative Examples 1 to 5. Table 1 also lists the boron content, the thickness of the carbon covering layer, and R (=S_{B}/(S_{B}+S_{C})).

The negative-electrode active materials of Comparative Examples 2 and 3 were compared. For boron-free graphite, the carbon covering layer on the surface of the graphite did not change the discharge capacity or irreversible capacity.

A comparison between the negative-electrode active materials of Comparative Examples 1, 4, and 5 and the negative-electrode active material of Comparative Example 3 shows that boron-containing graphite had a lower irreversible capacity but a lower discharge capacity than boron-free graphite.

However, in the negative-electrode active materials of Examples 1 to 4, the carbon covering layer on the surface of boron-containing graphite suppressed a decrease in discharge capacity due to the addition of boron and decreased the irreversible capacity. Examples 1 to 4 had an S_{B}/(S_{B}+S_{C}) ratio of 0.001 or less.

A comparison of Example 1 with Comparative Example 1 shows that the carbon covering layer on the surface of graphite with almost the same boron content increased the discharge capacity. A comparison of Example 1 with Example 2 shows that an increase in the thickness of the covering layer to approximately 55 nm further improved the discharge capacity. In Examples 1 to 4, the carbon covering layer had a thickness in the range of 30 to 55 nm.

These results show that the negative-electrode active material including boron-containing graphite covered with the boron-free carbon material can suppress a decrease in discharge capacity and decrease the irreversible capacity. This results in a high discharge capacity, a decreased irreversible capacity, and high reliability.

TABLE 1

| Negative- | Boron | Thickness | | | |
|---|---|---|---|---|---|
| electrode | content | of carbon | | Discharge | Irreversible |
| active | [mass | covering | S_{B}/ | capacity | capacity |
| material | %] | layer [nm] | (S_{B} + S_{C}) | [mAh/g] | [mAh/g] |
| Example 1 | 0.34 | 30 | <0.001 | 343 | 1.3 |
| Example 2 | 0.32 | 55 | <0.001 | 345 | 1.3 |
| Example 3 | 0.19 | 30 | <0.001 | 345 | 1.3 |
| Example 4 | 0.42 | 30 | <0.001 | 343 | 1.2 |
| Comparative | 0.35 | — | 0.052 | 339 | 1.3 |
| example 1 | | | | | |
| Comparative | — | 30 | <0.001 | 346 | 1.5 |
| example 2 | | | | | |
| Comparative | — | — | <0.001 | 346 | 1.5 |
| example 3 | | | | | |
| Comparative | 0.45 | — | 0.055 | 335 | 1.4 |
| example 4 | | | | | |
| Comparative | 0.30 | — | 0.004 | 339 | 1.4 |
| example 5 | | | | | |

A negative-electrode active material according to the present disclosure can be utilized in non-aqueous secondary batteries and is particularly useful as a negative-electrode material for non-aqueous secondary batteries, such as lithium-ion secondary batteries.

What is claimed is:

1. A negative-electrode active material for a non-aqueous secondary battery, the negative-electrode active material comprising:
a graphite including boron; and
a covering layer that covers a surface of the graphite, wherein
the covering layer comprises carbon, and
a ratio R satisfies 0≤R≤0.001, where R=S_{B}/(S_{B}+S_{C}), and S_{B} denotes a total peak area of a boron 1 s spectrum of the negative-electrode active material obtained by X-ray photoelectron spectroscopy, and S_{C} denotes a total peak area of a carbon 1 s spectrum of the negative-electrode active material obtained by X-ray photoelectron spectroscopy.

2. The negative-electrode active material according to claim 1, wherein the covering layer has a thickness of 30 nm or more.

3. The negative-electrode active material according to claim 1, wherein the graphite includes the boron in an amount of not less than 0.01% by mass and not more than 5% by mass of the total amount of the graphite.

4. The negative-electrode active material according to claim 2, wherein the graphite includes the boron in an amount of not less than 0.01% by mass and not more than 5% by mass of the total amount of the graphite.

5. The negative-electrode active material according to claim 1, wherein at least part of the carbon in the covering layer is amorphous carbon.

6. The negative-electrode active material according to claim 2, wherein at least part of the carbon in the covering layer is amorphous carbon.

7. The negative-electrode active material according to claim 3, wherein at least part of the carbon in the covering layer is amorphous carbon.

8. The negative-electrode active material according to claim 4, wherein at least part of the carbon in the covering layer is amorphous carbon.

9. A non-aqueous secondary battery comprising:
a positive electrode containing a positive-electrode active material that can occlude and release alkali metal ions;
a negative electrode containing a negative-electrode active material; and
a non-aqueous electrolytic solution, wherein
the negative-electrode active material comprises: a graphite including boron; and a covering layer that covers a surface of the graphite, and
a ratio R satisfies 0≤R≤0.001, where R=S_{B}/(S_{B}+S_{C}), and S_{B} denotes a total peak area of a boron 1 s spectrum of the negative-electrode active material obtained by X-ray photoelectron spectroscopy, and S_{C} denotes a total peak area of a carbon 1 s spectrum of the negative-electrode active material obtained by X-ray photoelectron spectroscopy.

10. The non-aqueous secondary battery according to claim 9, wherein the covering layer has a thickness of 30 nm or more.

11. The non-aqueous secondary battery according to claim 9, wherein the graphite includes the boron in an amount of not less than 0.01% by mass and not more than 5% by mass of the total amount of the graphite.

12. The non-aqueous secondary battery according to claim 10, wherein the graphite includes the boron in an amount of not less than 0.01% by mass and not more than 5% by mass of the total amount of the graphite.

13. The non-aqueous secondary battery according to claim 9, wherein at least part of the carbon in the covering layer is amorphous carbon.

14. The non-aqueous secondary battery according to claim 10, wherein at least part of the carbon in the covering layer is amorphous carbon.

15. The non-aqueous secondary battery according to claim 11, wherein at least part of the carbon in the covering layer is amorphous carbon.

16. The non-aqueous secondary battery according to claim 12, wherein at least part of the carbon in the covering layer is amorphous carbon.

17. The non-aqueous secondary battery according to claim 9, wherein the alkali metal ions are lithium ions.
